(19) United States
(12) Patent Application Publication
(10) Pub. No.: US 2009/0064503 A1
(43) Pub. Date: Mar. 12, 2009

(54) Cutter

(76) Inventor: David Martin Young, Bogue Chitto, MS (US)

Correspondence Address: STEVEN H GREENFIELD, 4649 SEMINOLE TRAIL, GREEN BAY, WI, 54313, US

(21) Appl. No.: 12/203,562

(22) Filed: Sep. 3, 2008

Related U.S. Application Data
(60) Provisional application No. 60/993,142, filed on Sep. 10, 2007.

(51) Int. Cl. B26B 29/06; B26B 13/12

(52) U.S. Cl. 30/231; 30/298.4; 30/289

(57) ABSTRACT

A device for cutting a thin material such as a foil, fabric, paper and condiment packet is disclosed. The device is particularly suited for persons who lack dexterity in their fingers or palms and have difficulty using scissors for cutting. The device comprises of an angled blade adapted for movement along an axis perpendicular to a plane defined by the material, and a straight stationary blade that together impart a shearing action onto the material. For safe operation, the device is encased in an enclosure having a slot for inserting the material.

### RELATED APPLICATIONS

This application claims priority from provisional application No. 60/993,142 filed on Sep. 10, 2007.

### FIELD OF THE INVENTION

The present invention relates to a device for cutting thin materials such as foil, fabric and paper. The device is particularly suited for persons who lack dexterity in their fingers or palms and thus have difficulty using scissors for cutting.

### BACKGROUND OF THE INVENTION

Scissors are commonly used for cutting thin materials such as paper, foil or fabric. The principle involved is shear cutting in which the thin material is placed between two blades, at least one of which is angled in relation to the plane defined by the sheet. The angled blade, also referred to as the shear, is urged to move along the line of the desired cut creating a slicing action on the sheet. In a pair of scissors, the blades are arranged in an X shape and pivoting along two substantially parallel planes. Thus, in the case of scissors, the shear cutting is accomplished by two angled and moving blades. However, shear cutting can be accomplished in a similar manner by using an angled movable blade that is urged onto a thin material in a plane perpendicular to the plane defined by the thin material, and a straight stationary edge disposed opposite to the moving blade in a plane perpendicular to the plane defined by the thin material. The straight stationary blade provides support for the thin, and typically flexible, film against which the angled blade slides when the shearing is performed. A guillotine is an example of a shear cutting implement used for sheet metal. The guillotine comprises of an angled blade driven down onto the metal along the length of the cut shearing it off cleanly.

A number of embodiments for cutters that operate on a similar principle or produce a similar result have been disclosed in the art. U.S. Pat. No. 5,000,070 relates to a cutter for cutting a thin material by engagement between a movable blade and a fixed blade comprises a spring member which is disposed between the movable blade and a movable base for moving the movable blade in the direction of engagement and is adapted to urge the movable blade in a direction perpendicular to the linearly reciprocal motion of the movable base so as to bring the movable blade into contact with the fixed blade. U.S. Pat. No. 6,715,389 is directed to an apparatus for opening condiment packets, having a base and a support that define an opening to receive a condiment packet. A cutter subassembly connected to the support is used to cut the packet received in the opening. The cutter subassembly includes an upper body portion that releasably connects to the support, a lower body portion, a rod that extends through the upper and lower body portions, a handle connected to a top end of the rod, a cutter connected to a lower end of the rod, and a spring system that controls movement of the cutter and lower body portion relative to the upper body portion.

### SUMMARY OF THE PRESENT INVENTION

It is the object of the present invention to provide a simple device for shear cutting thin materials for persons who have limited dexterity in their hand and/or fingers and thus have difficulty using scissors due to arthritis, MS, or injury. Operating this device requires only the use of one finger and pressing one button. It is also the object of the present invention to provide the above mentioned device for cutting the ends of condiment packages for persons with limited hand and/or finger dexterity and thus have difficulty tearing open packets of condiments such as ketchup, mayonnaise, taco sauce or mustard in a restaurant or at home. It is further the object of the present invention to provide the above mentioned device as a lightweight, compact size and portable attachment to a key chain for convenient carrying. It is yet further the object of the present invention to provide an enclosure in which the cutter is encased to avoid exposing fingers to the blades, thus assuring that the operation of the device is safe and injury free.

### BRIEF DESCRIPTION OF THE DRAWINGS

FIG. 1 is a top view of the device of the present invention

FIG. 2 is a top view of the device of the present invention showing the location of the inner components.

FIG. 3 is an exploded top view of the device of the present invention showing the assembled components.

FIG. 4 is a front view of the device of the present invention.

FIG. 5 is a front view of the device of the present invention indicating the inner components.

FIG. 6 is an exploded front view of the device of the present invention showing the assembled components.

FIG. 7 is a side cross sectional view of the device of the present invention showing the inner components and their relative positions when the device is not in use.

FIG. 8 is a side cross sectional view of the device of the present invention indicating the inner components and their relative positions as the cutting of an object is performed.

FIG. 9 is an illustration of the exploded side view of the device of the present invention showing the assembled components.

FIG. 10 is a top view of the device of the present invention showing a condiment packet inserted into the device in position for cutting.

FIG. 11 is a representation of the device of the present invention connected to a key chain.

FIG. 12-14 represent dimensional views of the various components of the present invention's preferred embodiment.

FIG. 15-19 are three-dimensional representations of an alternate embodiment of the present invention device.

FIG. 15 is a three-dimensional representation of the top front view of the present invention device.

FIG. 16 is a three-dimensional representation of the back top view of the present invention device.

FIG. 17 is a three-dimensional representation of the bottom front view of the present invention device.

FIG. 18 is a three-dimensional exploded view of the components of the embodiment represented by FIG. 15-17 viewed from the top and side.

FIG. 19 is a three-dimensional exploded view of the components of the embodiment represented by FIG. 15-17 viewed from the bottom and side.

### DETAILED DESCRIPTION OF THE INVENTION

In one aspect of the invention, the cutting device comprises of an enclosure having a positioning slot through which a thin material is inserted and sheared by the cutting device. In another aspect of the invention, the device comprises of the components of a first blade assembly, a support system for the first blade assembly, and a second blade assembly. The enclosure is the result of assembling these components.

In the preferred embodiment of the present invention, the first blade assembly comprises a first frame having an outside, an inside and an opening at substantially the center of the frame, and a blade body comprising an angled blade attached to a base that has a top side and a bottom side. The base is adapted to fit through the opening of the first frame in a manner that permits the base to move through the opening of the first frame. The bottom side of the base containing the angled blade has a thin ledge that protrudes outwardly. The top side of the base is designed to fit through the opening in the first frame in a manner that positions the ledge against the inside of the first frame thus permitting movement of the base toward the inside of the frame but limiting movement of the base toward the outside of the frame. The support system is comprised of at least two coiled spring members for supporting the base. The second blade assembly comprises a second frame having an outside and an inside and a straight stationary blade attached to the inside of the second frame.

The first and second blade assemblies are made of plastic while the coil spring members are made of metal. In the preferred embodiment of the present invention, the base is rectangular in shape having four rounded comers, and the support system comprises of four coil spring members each positioned to support one corner of the base. Another key function of the spring members is the return of the base back to its original position as the spring members are allowed to recoil after the cutting action is completed. Also in the preferred embodiment of the present invention, the device is formed into one integral piece. An alternate embodiment of a modular design, in which the components are combined in a manner that permits disassembling the components of the device, also falls within the scope of the present invention.

The assembly of the components results in an enclosure having a positioning slot for placing and positioning an object, typically a thin material such as a sheet, a foil or a packet, which requires cutting. The assembled system is configured for the angled blade to be disposed in a position above the object and to move toward the object in a perpendicular orientation in relation to it. The system configuration also provides for the object to be disposed above the straight stationary blade and to rest on it. The angled blade movement defines a plane parallel to the plane defined by the straight stationary blade in a manner that avoids overlap and contact of the angled and straight stationary blade edges. The plane defined by the straight stationary blade is slightly offset relative to the plane defined by the movement of the angled blade. As the angled blade is urged toward the thin material to be cut and as the cutting takes place, one side of the angled blade slides along the opposite side of the straight stationary blade much like the two blades of a pair of scissors. A containment slot is designed into the second frame next to the straight stationary blade for containing the angled blade during the cutting process.

In the assembled form of the device, the top part of the base is inserted through the bottom side of the first frame opening in a manner that brings the ledge against the bottom of the first frame. In this position, the spring members supporting the base are compressed and exert pressure against the base pinning the ledge against the inside of the first frame. The ledge serves to prevent the base from being dislodged from the frame as a result of pressure from the compressed spring members. Applying finger pressure on the base urges the base and the angled blade attached to it toward the object thereby applying pressure onto the spring members. The pressure compresses the coil spring members as the base and angled blade move toward the object and the angled blade cuts it. Once the cutting is completed, the pressure on the base is released allowing the spring members to recoil and push the base and the angled blade to its original position. While a variety of base shapes fall within the scope of the present invention including, but not limited to, circular, oval, square, and hexagonal, a substantially rectangular base having rounded corner is preferred for positioning the springs to achieve proper support. This design also provides a “button” large enough that a dexterity challenged individual can press to activate the cutter.

In the preferred embodiment of the present invention, the combination of the first frame and the second frame produces an assembled device of a substantially triangular shape having a front side that contains the positioning slot for inserting the object to be cut, and two lateral sides. In one embodiment of the present invention vertical guides are located inside the positioning slot for fixing the object that requires trimming, such as a condiment packet, typically for a 45 degree cut. A hole may be drilled through the second frame at the juncture point of the lateral sides for optionally attaching the device onto a key chain.

The preferred dimensions for the device are a front side length of between about 2″ to about 3″ for the front side, and a preferred length of about 2 11/32″ and lateral side length of between about 1″ to about 2″ with a preferred length of 1 23/32″. The angle of the moving blade may range from about 3 degrees to about 10 degrees relative to the base with a preferred angle of 5 degrees. The dimensions of the preferred spring members used for supporting and moving the angled blade base are: a diameter of about 0.12″, a compressed height of about 0.3″ and a wire diameter from about 0.015″ to about 0.02″. The spring members are situated on a 0.075″ posts for keeping them in place.

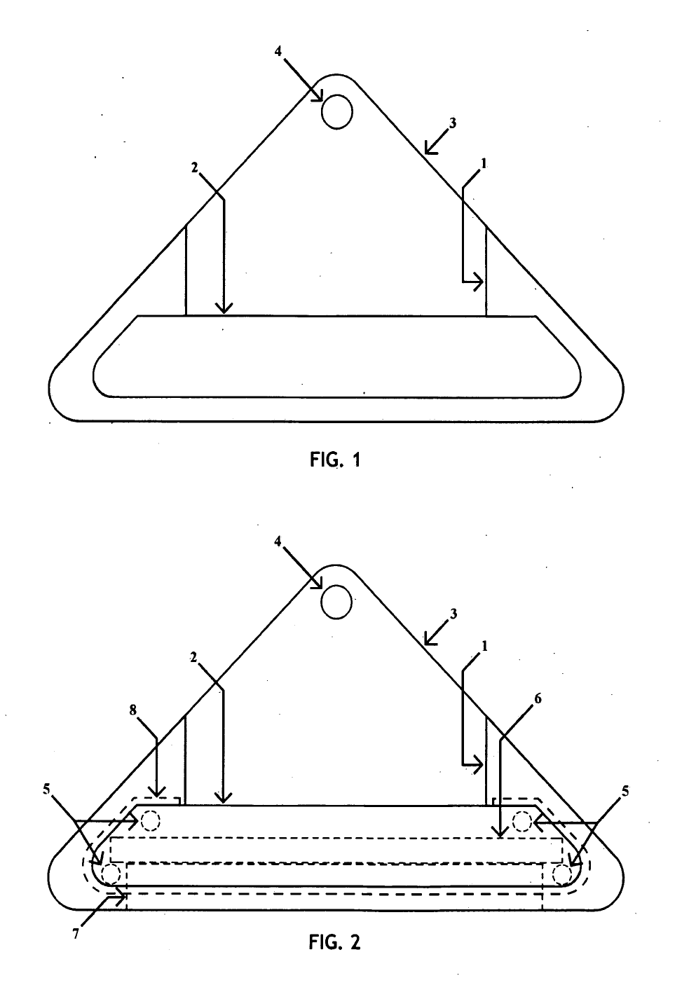

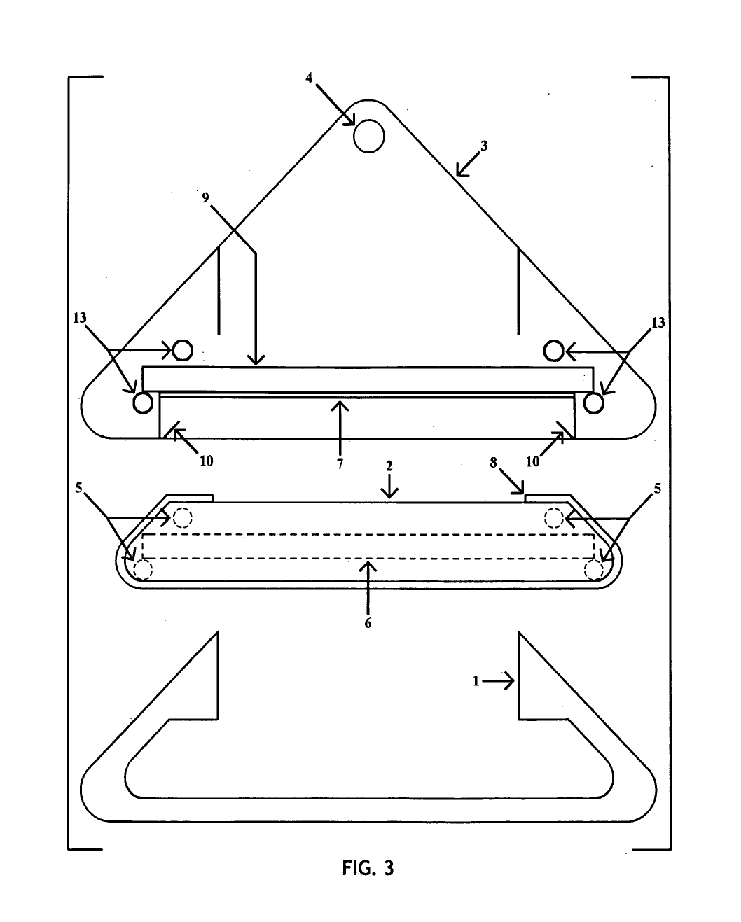

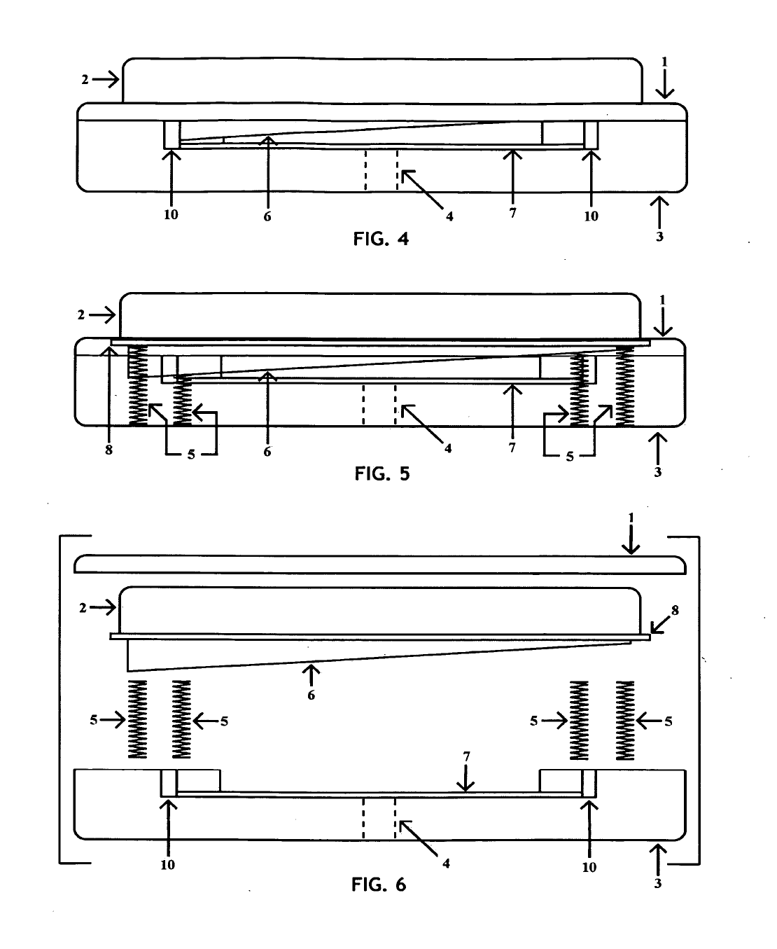

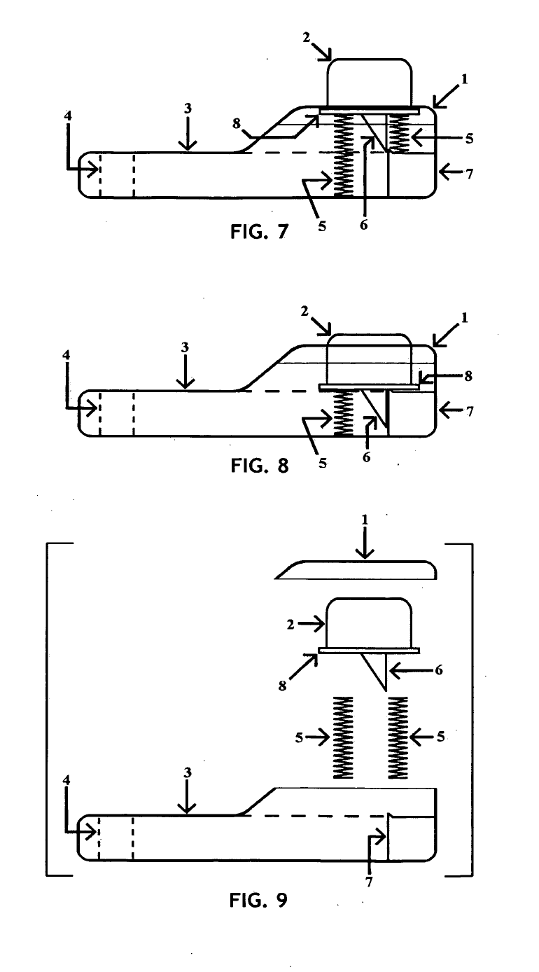

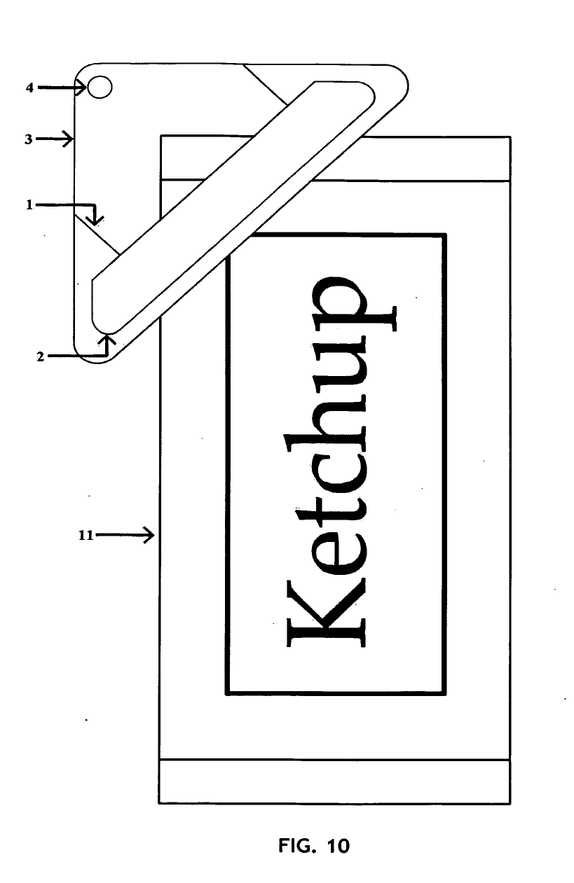

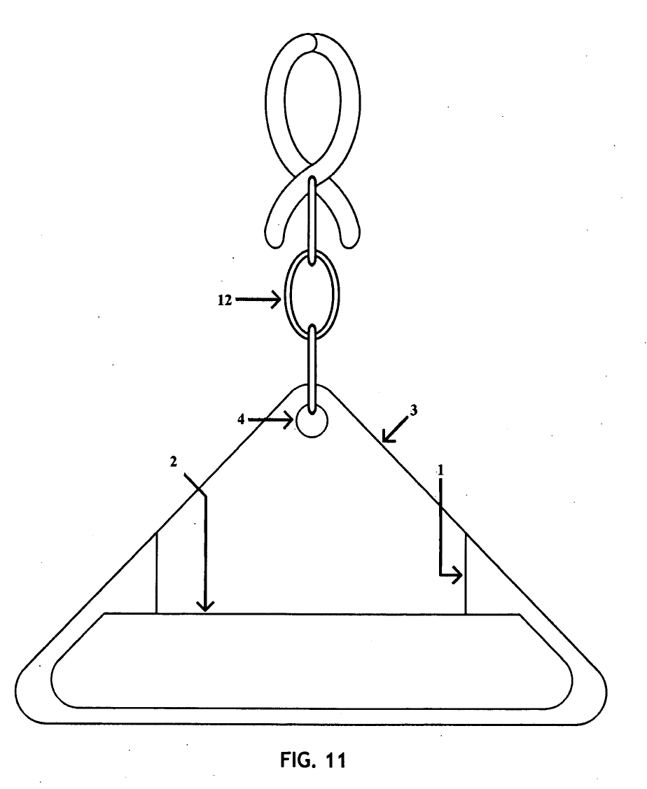

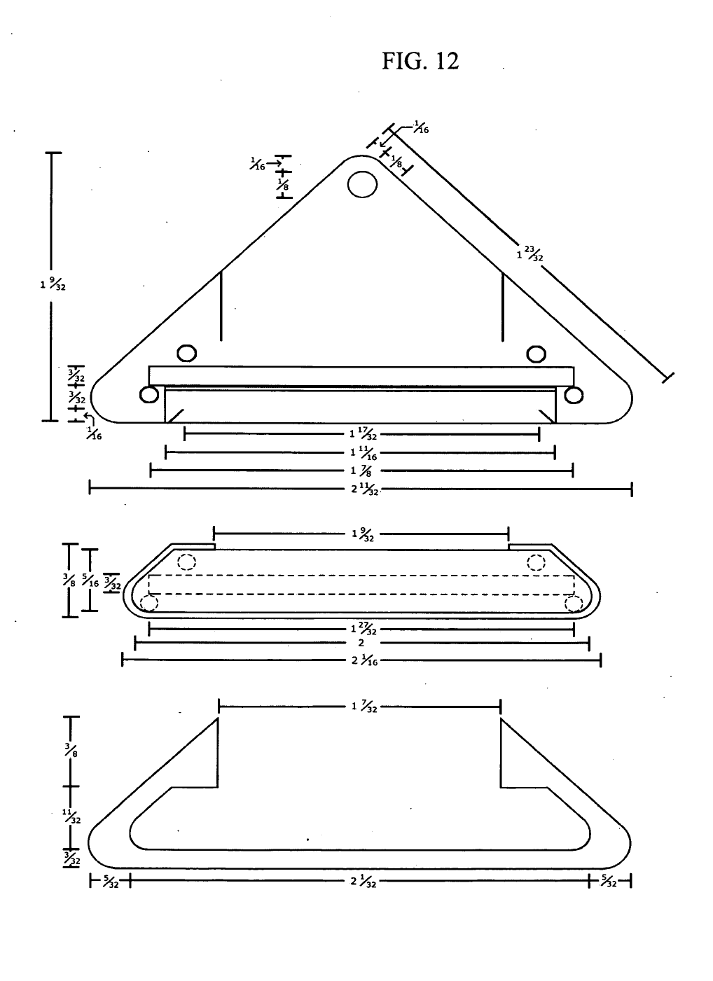

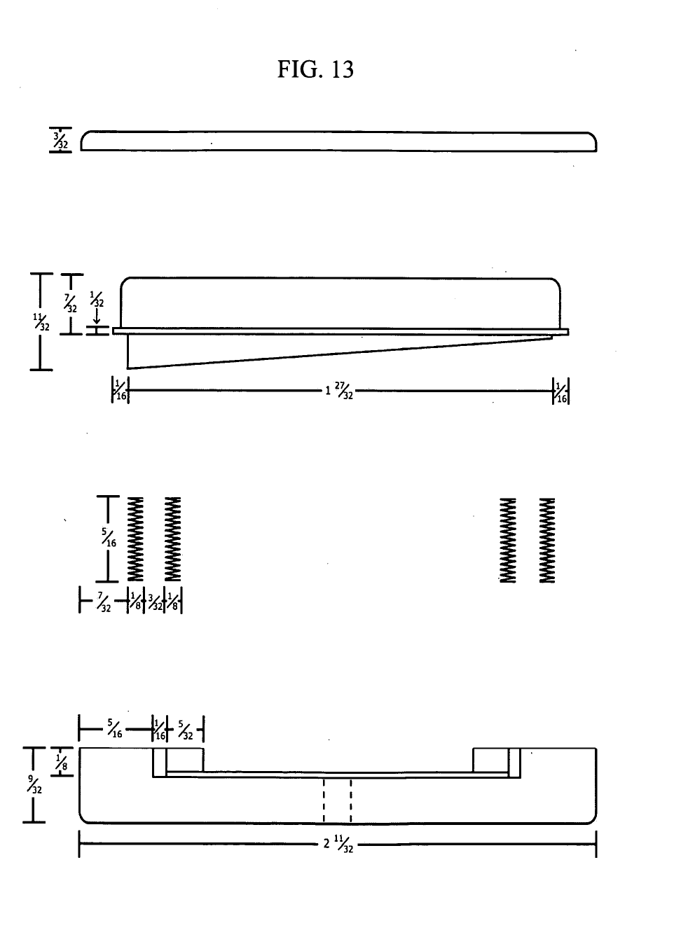

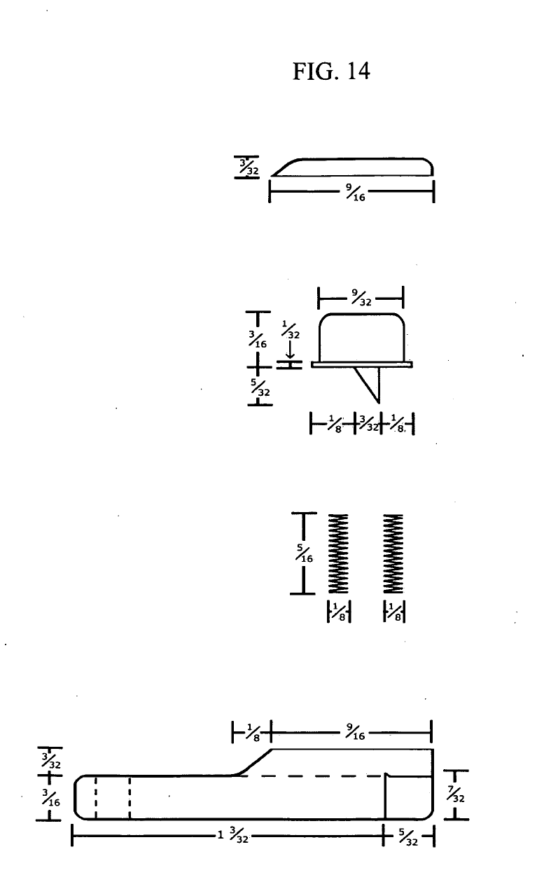

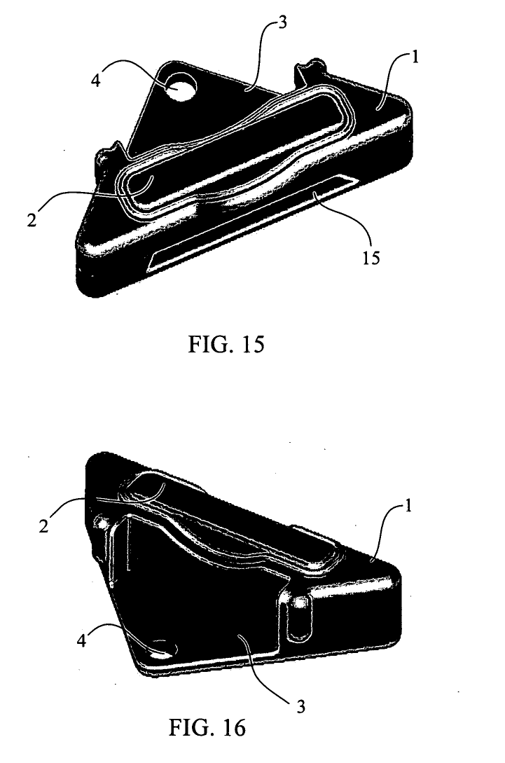

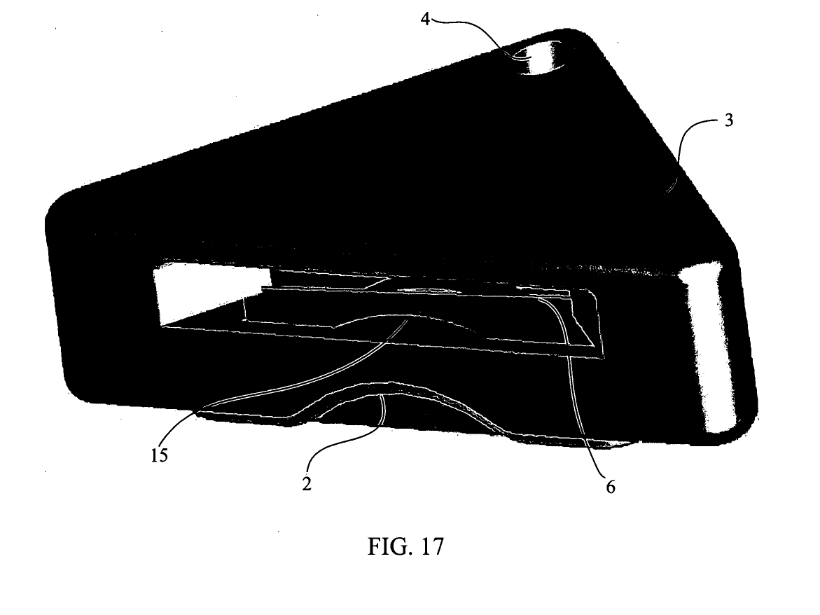

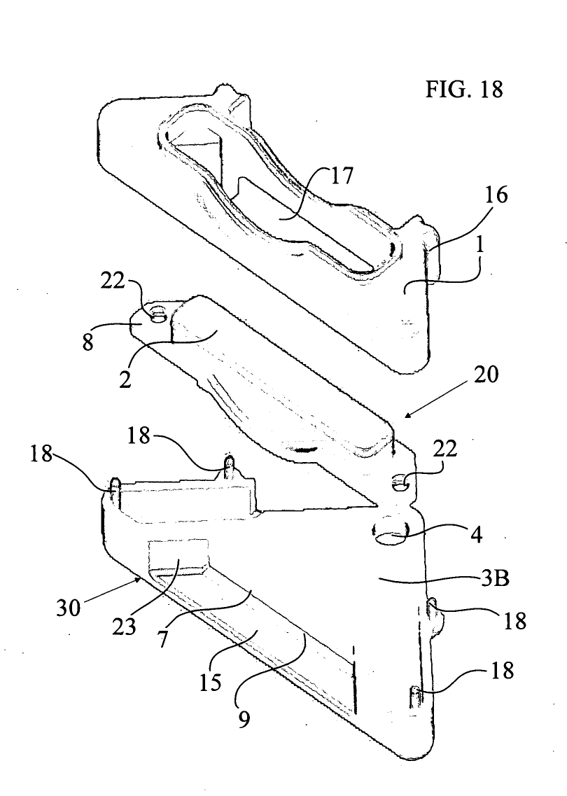

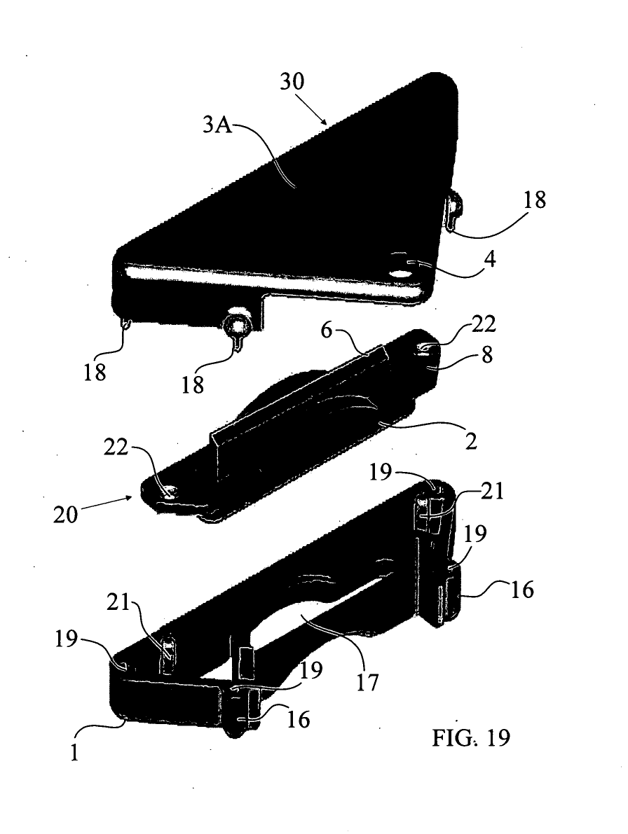

Referring to FIG. 1, the device has a first frame (1), a base (2) positioned onto the top side of the first frame (1) and a second frame (3) comprising a hole (4) for attaching the device to a key chain. Referring to FIG. 2, the locations of fours spring members (5) are shown located below the base (2) as are the angled blade (6), the straight stationary blade (7) and the ledge (8) for maintaining the position of the base (2). FIG. 3 shows a containment slot (9) used for containing the angled blade (6) in the cutting process and guides (10) for positioning the object that requires trimming at a 45 degree angle. The posts used for holding the springs in place are indicted by (13). These components are shown from other angles in FIG. 4-9. FIG. 10 indicates a ketchup packet (11) positioned inside the device for a 45 degree cut. The device is shown clipped onto a key chain (12) in FIG. 11. FIG. 15-17 illustrate an alternate embodiment of device of the present invention indicating the first frame (1), the base (2) positioned onto the top side of the first frame (1) and the second frame (3) comprising the hole (4) for attaching the device to a key chain. The positioning slot (15) for inserting the object to be cut is situated at the front of the device through which the angled blade (6) can be seen. FIG. 18-19 illustrate the main components of this embodiment of the device showing the first frame (1), the blade body (20), and the second blade assembly (30). The blade body (20) comprises the base (2), the angled blade (6) and the ledge (8). The first frame (1) comprises the opening (17) for the blade body base (2), apertures (19) for inserting and locking the rods (18) located on the second frame (30), and receptacles for the rods (16). The second blade assembly (30) comprises the second frame (3), the straight stationary blade (7) and attaching and locking rods (18). Shown also are the positioning slot (15) through which the object to be cut is inserted, positioning guide (23), the hole (4) for attaching the device to a key chain, and the containment slot (9) for containing the angled blade (6) in the cutting position. The inside of the second frame (3B) is indicated in FIG. 18 and the outside of the second frame (3A) is shown in FIG. 19. In the embodiment represented by FIG. 15-19, two springs are used. The springs are held and supported by two posts (21) located on the inside of the first frame (1). The posts (21) insert through guiding apertures (22) in the ledge (8) of the blade body (20) used for guiding the movement of the blade body (20). Not shown are the springs. The aforementioned embodiment of the device includes means for attaching the components to form one unit. These means include attaching and locking rods (18), apertures for inserting and locking the rods (19), and receptacles for the rods (16).

I claim

1. A device for cutting an object, said object being disposed along a first plane comprising
A. a first blade assembly containing a first frame having an inside, an outside, and an opening, said first blade assembly also containing a blade body, said blade body being adapted to fit into said opening for movement along a second plane, said second plane being substantially perpendicular to the first plane, said blade body comprising a base having a top, a bottom and an angled blade, said angled blade being attached to the bottom of said base in a substantially perpendicular relation to said bottom of the base, said bottom of the base also comprising a ledge extending outwardly from said base in a manner that disposes said ledge against the inside of said first frame;
B. a second blade assembly containing a second frame disposed substantially along the first plane, said second frame having an inside and an outside, said second blade assembly also containing a straight stationary blade, said straight stationary blade being attached to the inside of said second frame in a substantially perpendicular relation to said first plane;
C. two or more coil spring members disposed between the base and the second frame; and
D. attaching means for combining said second blade assembly to said first blade assembly.

2. The device of claim 1, wherein the first blade assembly and the second blade assembly are combined to form a substantially triangular enclosure having a front side and two lateral sides, said lateral sides forming a juncture, said front side comprising a positioning slot for inserting the object for cutting.

3. The device of claim 1, in which said base is substantially rectangular having four rounded corners.

4. The device of claim 3, wherein the device comprises of four spring members disposed at the corners of said base.

5. The device of claim 2, further comprising a hole for attaching said device to a key chain, said hole being disposed at the juncture of said lateral sides.

6. The device of claim 1, wherein each coil spring members is positioned on a post, said posts being attached to the inside of said first frame.

7. The device of claim 1, wherein each coil spring members is positioned on a post, said posts being attached to the inside of said second frame.

8. The device of claim 1, wherein the angled blade and the straight stationary blade are disposed in a manner as to define substantially parallel planes, said angled blade and said straight stationary blade being disposed to slide along each other.

9. The device of claim 1, wherein the second frame further comprises a containment slot, said containment slot being positioned alongside the straight stationary blade.

10. The device of claim 1, wherein said device is manufactured into one integral unit.

11. The device of claim 1, wherein said device is manufactured of modular units adapted for disassemble and reassemble.

12. The device of claim 1, further comprising guides for positioning the object to be cut.

13. The device of claim 1, wherein the angle of the angled blade relative to the bottom of the base ranges from about 3 degrees to about 10 degrees.

14. The device of claim 1, wherein the angle of the angled blade relative to the bottom of the base is about 5 degrees.
